(19) United States
(12) Patent Application Publication
(10) Pub. No.: US 2008/0050572 A1
(43) Pub. Date: Feb. 28, 2008

(54) Novel Method for the Synthesis/Production of Acrylic Films

(76) Inventors: Olivier Guerret, Mazerolles (FR); Gerard Pierre, Denguin (FR)

Correspondence Address: Steven D Boyd;Arkema Inc, 2000 Market Street, 26th Floor, Philadelphia, PA, 19103, US

(21) Appl. No.: 10/550,808

(22) PCT Filed: Mar. 23, 2004
(86) PCT No.: PCT/FR04/00713

§ 371 Date: Jan. 26, 2007

(30) Foreign Application Priority Data
Mar. 26, 2003 (FR) 03/03681
Sep. 24, 2003 (FR) 03/11174

(51) Int. Cl. B32B 27/36; C08L 33/04

(52) U.S. Cl. 428/220; 525/94

(57) ABSTRACT

The invention relates to the use of block copolymers, obtained by controlled radical polymerization in the presence of alkoxyamine derivatives of substituted nitroxides, for the production of perfectly transparent acrylic films with the mechanical properties required for the applications envisaged, whereby the transparency thereof remains under mechanical stress and a wide temperature range. The total thickness is between 40 and 300 microns, preferably 70 to 90 microns. The film has a haze of less than 2 and elongation at breakage of more than 90%.

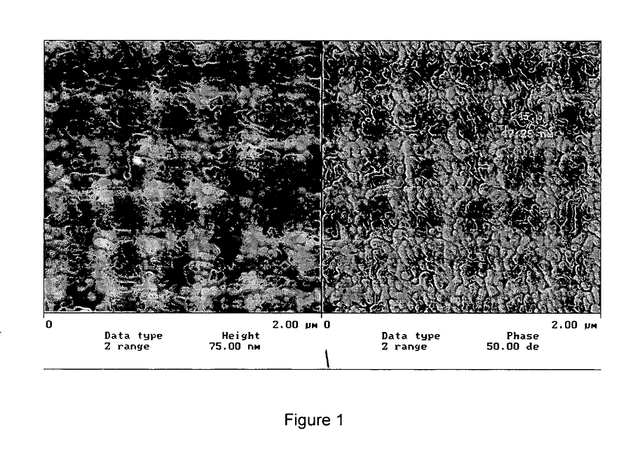

The present invention relates to the field of acrylic materials, particularly to acrylic materials intended to coat certain thermoplastics and more particularly to the field of monolayer acrylic films.

Acrylic resins are thermoplastic polymers which are being increasingly used because of their exceptional optical properties and their ease of forming. Mention may in particular be made of their glossy appearance, their very high degree of transparency, with at least 90% light transmission, their hardness, their suitability for thermoforming and their resistance to aging, in particular to atmospheric agents (more particularly to UV radiation).

For these reasons, both technical and esthetic, it is important to find transparent and ductile acrylic films for protecting plastic components possessing limited resistance to aging. This is because, while such films, due to their acrylic nature, are highly resistant to UV radiation (durability) and make it possible to contribute this same property to the component on which they are deposited, there is a risk that they, due to the brittle nature of methacrylic materials, will render brittle the combined coated component. To have acrylic materials which are sufficiently ductile to be deposited on components made of ABS (acrylonitrile-butadiene-styrene copolymer), PVC (poly(vinyl chloride)), PC (polycarbonate), PP (polypropylene) and PS (polystyrene) is thus a challenge of the greatest importance.

Mention may in particular be made, among the forming techniques appropriate for this purpose, of the in-mold decoration technique.

According to this technique, an acrylic film, preferably stored in the form of a roll, is preformed in a 1st stage (optionally preceded by continuous hot bonding with another thermoplastic film or substrate in a stage referred to as a colaminating stage) to the required geometry, so as to match the inside surface of the mold intended to form the desired object.

In a 2nd stage, the molten thermoplastic resin is injected into the mold and brought into contact with the film, which has the effect of causing the film to adhere to the surface of the object thus formed.

A particularly preferred embodiment of this technique comprises the simultaneous implementation of the 2 stages described above using an appropriate device. This embodiment is denoted under the term of film insert molding (FIM).

The acrylic films used in this technique can be used as is, in other words while retaining a transparency. They can also be colored, while retaining their glossy appearance. Finally, they can receive, by a specific printing process, a design, a pattern, an image or even characters, text or a logo suitable for conveying information to the consumer. Mention may be made, as printing example, of the printing of a design which imitates the appearance of wood.

The designs or patterns printed on the transparent acrylic film can thus be applied to the surface of the object made of thermoplastic resin, in particular by FIM. The film thus printed improves the aging of the object thus coated. Furthermore, as it carries the pattern or design printed on that one of its 2 surfaces which is in contact with the substrate, it also protects the pattern from contact with atmospheric agents and adds a visual effect of relief to the design which is particularly desirable.

Mention may be made, among the routes which currently exist for producing such products, of the following two: the first consists in blending, with an acrylic resin, sufficient impact modifier of core-shell type (Röhm WO 99 29766 and U.S. Pat. No. 6,420,033 B1, Sumitomo EP 1000 978 A1, Mitsubishi Rayon EP 0 763 560 A1) to render it ductile.

U.S. Pat. No. 6,147,162 discloses a monolayer acrylic film manufactured from a composition comprising 50 to 95% of a specific acrylic resin and 5 to 50% of a multilayer acrylic polymer comprising an elastomeric layer. Said polymer (also known by a person skilled in the art under the name of impact modifier) is dispersed in the acrylic resin. This film is suitable for the FIM technique and provides the object thus coated with good surface hardness.

EP 1000978 A1 also discloses an acrylic film manufactured from a composition comprising 50 to 95% of a specific acrylic resin and 5 to 50% of an impact modifier which is suitable for coating by employing the FIM technique and which has an improved surface hardness. Furthermore, this document mentions a laminated film (that is to say a multilayer film) and more specifically a two-layer film, the inner layer of which is composed of the composition described above and the outer layer of which is composed of an acrylic resin devoid of impact modifier. This two-layer film, presented as having an excellent surface hardness, can furthermore be wound off in the form of a roll.

U.S. Pat. No. 6,444,298 B1 discloses a laminated (or alternatively multilayer) acrylic film comprising a layer comprising an acrylic resin and particles of acrylic elastomer (corresponding to an impact modifier), referred to as flexible layer, and a layer comprising an acrylic resin devoid of impact modifier, referred to as surface layer. A three-layer system is also disclosed in which 2 surface layers are separately bonded to the 2 surfaces of the flexible layer. Such a multilayer film makes it possible to improve the coloring treatment while avoiding the bleaching and the fading of the coloring of the resin related to the presence of the impact modifiers. This patent recommends taking care that the ratio of the thickness of the flexible layer to the total thickness of the film be between 50 and 100%, preferably between 60 and 100%.

In the context of a highly automated industrial process for printing on acrylic film, the latter, during its passage through rotary printing machines, is subjected to very high tensile stresses and, in order to withstand these, it must exhibit a high elongation at break (measured at ambient temperature), for example of greater than 50%, preferably than 60%.

The passage of the film through the rolls present in the printing devices and its ability to be wound in the form of a roll in order to continuously feed such devices also require a very high flexibility corresponding to a tensile elastic modulus (or Young's modulus) of between 300 and 1800 MPa, preferably between 500 and 1200 MPa.

This method, which consists in blending sufficient impact modifier of core-shell type with an acrylic resin, is limited in that, as the size of the core-shell particles is greater than or equal to 50 nm, the transparency of the material is ensured only by the appropriateness of the refractive indices of the particles and of the acrylic resin. This appropriateness is only valid within a given temperature range and the material turns white outside this temperature range.

The second method also attempts to solve the problem of the transparency: it consists in using block copolymers of (A)ₙ-B type where A is a block compatible with PMMA and B is an acrylate block with a low glass transition temperature. Such products are said to be organized at the nanometric scale into acrylate domains and methacrylate domains. The small size of these domains provides good transparency of the materials at visible wavelengths, whatever the temperature.

Thus, Kaneka (Patent Application JP2000-397401) claims materials comprising at most 95% of block copolymers in order to be used as films. Even if it demonstrates the advantage of the block copolymers, this invention is of limited industrial interest as it requires the blending of the block copolymers and of the PMMA homopolymer, in addition to the manufacture of these materials. Furthermore, this invention uses catalysis with copper complexes to synthesize these block copolymers, which is totally unacceptable for applications where the level of transparency of the resins has to be as good as possible as copper complexes are highly colored molecules. Moreover, in order for the block copolymers disclosed in this invention to be of use in the manufacture of an acrylic film, they have to be blended with core-shell additives at a content of between 5 and 95%. Such a blending, in addition to constituting an additional stage in the manufacture of the film, limits the scope of the invention since it suffers from the same drawbacks as those mentioned in the first film manufacturing method (maintaining the optical properties in the presence of core-shell particles).

The Applicant Company, in seeking to solve the problems referred to above, namely the production of a film having good resistance properties, both mechanical and a resistance with regard to external attacks, and good transparency, has found that some block copolymers, carefully selected from known families of block copolymers, make it possible to achieve the objective described above without having recourse to additional core-shell additives. The distinctive feature of the invention is that of preparing films comprising at least 95% of block copolymers.

The copolymers of the invention are obtained by controlled radical polymerization in the presence of nitroxides, as described below.

In particular, the present invention discloses the chemical compositions of block copolymers necessary for producing acrylic films having a modulus of between 300 MPa and 1800 MPa and a high transparency. By the term “chemical composition”, the Applicant Company intends to specify the nature of the monomers participating in the formation of each block, the ratio of these monomers, the number-average and weight-average molecular masses and the level of copolymers in the final material.

An aim of the present invention is thus to produce an acrylic film which, while maintaining its qualities of transparency, simultaneously has a very high elongation at break (allowing it in particular to withstand passage through printing devices), combined with an elastic modulus offering the very good flexibility necessary for the storage of the film as a roll.

The film of the invention is a film obtained by techniques for the conversion of thermoplastics, such as extrusion, starting from a composition comprising:
from 95 to 100% by weight of at least one block copolymer corresponding to the formula (A)ₘ-(B)ₙ-I and
from 0 to 5% by weight of at least one polymer, the composition of which corresponds to the A block of the copolymer, n being an integer greater than or equal to 2, m being an integer less than or equal to n, B being a polymer block, bonded directly to the core I via a covalent bond, obtained by the polymerization of a mixture of monomers (B₀) comprising at least 60% by weight of acrylic monomers (b₁) and A being a polymer block, bonded directly to the B block via a covalent bond, obtained by the polymerization of a mixture of monomers (A₀) comprising at least 60% by weight of methacrylic monomers (a₁).

The core (I) is an organic group having n (greater than or equal to 2) carbon atoms to which are attached the B blocks via one of the valences of these carbon atoms. I corresponds to one of the following general formulae Ia, Ib and Ic:

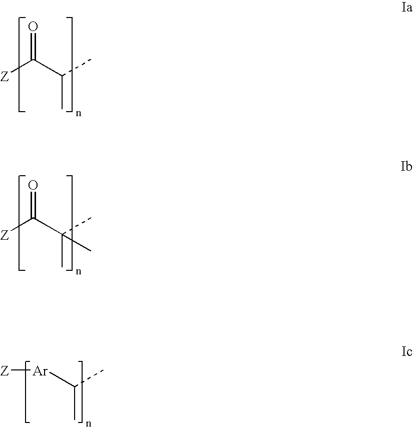

Ia, Ib and Ic result from the thermal decomposition of the corresponding alkoxyamine as described later (formulae II), where Ar denotes a substituted aromatic group and Z is a polyfunctional organic or inorganic radical with a molar mass of greater than or equal to 14. Z is associated with n functional groups of acryl type in the formula Ia, with n functional groups of methacryl type in the formula Ib and with n functional groups of styryl type in Ic. Mention may be made, as nonlimiting examples of the scope of the invention, that Z can be a polyalkoxy, in particular dialkoxy, group, such as the 1,2-ethanedioxy, 1,3-propanedioxy, 1,4-butanedioxy, 1,6-hexanedioxy or 1,3,5-tris(2-ethoxy)-cyanuric acid radicals; a polyaminoamine group, such as polyethyleneamines or 1,3,5-tris(2-ethylamino)cyanuric acid; a polythioxy group; or a phosphonate or polyphosphonate group. Z can also be an inorganic group, for example an organometallic complex such as: Mⁿ⁺O⁻ₙ; the second valency of the oxygen atoms corresponds to the bond which appears between Z and the acryl, methacryl and styryl groups. M can be a magnesium, calcium, aluminum, titanium, zirconium, chromium, molybdenum, tungsten, manganese, iron, cobalt, nickel, palladium, platinum, copper, silver, gold, zinc or tin atom.

B is a polymer block, bonded directly to the core I via a covalent bond, obtained by the polymerization of a mixture of monomers (B₀) comprising at least 60% by weight of acrylic monomers (b₁). It exhibits a glass transition temperature (T_{g}) of less than 0° C., a weight-average mass (M_{w}) of between 40 000 and 200 000 g/mol and a polydispersity index (PI) of between 1.1 and 2.5 and preferably between 1.1 and 2.0. According to the invention, the mixture of monomers B₀ comprises:
from 60 to 100% by weight of at least one acrylic monomer (b₁) chosen from alkyl acrylates having an alkyl chain comprising at least two carbon atoms and preferably at least four carbon atoms, such as butyl acrylate, octyl acrylate, nonyl acrylate, 2-ethylhexyl acrylate, polyethylene glycol acrylates or acrylonitrile,

The other monomers (b₂) participating in the structure of the B block are chosen from monomers which can be polymerized by the radical route, such as ethylenic, vinyl and similar monomers.

The A block has to exhibit a good affinity with the materials which it is desired to cover with a film.

The A block according to the invention exhibits a T_{g} of greater than 50° C. It is obtained by the polymerization of a mixture of monomers A₀ comprising:
from 60 to 100% by weight of at least one methacrylic monomer (a₁) chosen from alkyl methacrylates, such as methyl, butyl, octyl, nonyl or 2-ethylhexyl methacrylate, or also functional methacrylic derivatives, such as methacrylic acid, glycidyl methacrylate, methacrylonitrile or any methacrylate comprising an alcohol, amide or amine functional group,
from 0 to 40% by weight of at least one monomer (a₂) chosen from anhydrides, such as maleic anhydride, vinylaromatic monomers, such as styrene or its derivatives, in particular α-methylstyrene, and the monomers corresponding to (b₁).

Furthermore, the mixture A can comprise a proportion of the monomers used for the B block. This proportion is at most equal to 20% of the mixture of the monomers used for the A block.

The weight-average molecular mass (M_{w}) of the block copolymer (A)ₘ-(B)ₙ-I is between 80 000 g/mol and 300 000 g/mol with a polydispersity of between 1.5 and 2.5.

Given that monomers resulting from the B block may be components of the A block, it is advisable, in order to fully describe the copolymer, to specify its overall content of monomers suitable for the B block and the ratio of B block to A block. These two ratios are not necessarily the same.

The copolymer (A)ₘ-(B)ₙ-I comprises between 60% and 10% by weight of monomers (B₀) and preferably between 50 and 25%. The proportion of B block in the block copolymer is between 10 and 50%, preferably between 20 and 50%.

The process for the preparation of the copolymers (A)ₘ-(B)ₙ-I thus consists in initiating the polymerization of the monomer or monomers (B₀) necessary for the B block by an initiator of alkoxyamine type. The choice of the initiators of the invention is essential for the success of the manufacture of the material: this is because these initiators make it possible to control the number of arms of the block copolymer and the satisfactory sequencing thereof. The latter characteristic depends on the choice of the nitroxide control agent produced by the decomposition of the initiating alkoxyamines. The general formulae of the alkoxyamine initiators chosen according to the invention are therefore as follows:

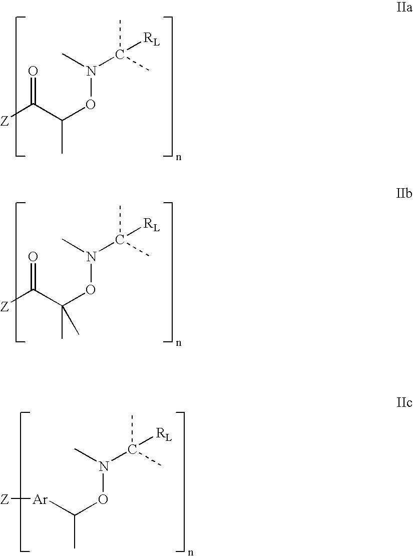

in which:

Z has the same meaning as above and the carbon atom in the alpha position with respect to the NO bond carries at least one organic group R_{L} with a molecular mass of greater than or equal to 16 g/mol. The other valences of the nitrogen or of the carbon in the alpha position carry organic groups, such as linear or branched alkyl groups, such as tert-butyl or isopropyl, which are optionally substituted, such as 1,1-dimethyl-2-hydroxyethyl, hydrogen atoms or aromatic rings, such as the optionally substituted phenyl group.

The preferred alkoxyamines of the invention are those corresponding to the following formulae:

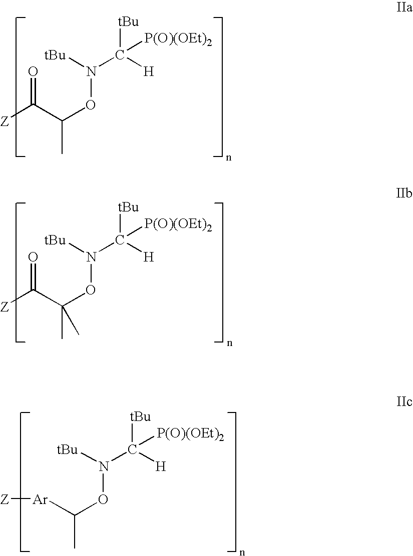

These molecules II are associated with nitroxides X corresponding to the general formula:

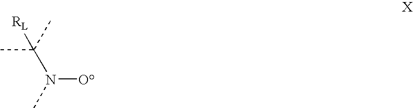

R_{L} and the groups attached to the nitrogen atom and to the carbon atom in the alpha position with respect to the nitrogen have the same meanings as above.

The choice of n, integer greater than or equal to 2, makes it possible in particular to provide a very high level of block copolymers in the final material, the presence of unreacted B block after the formation of A being limited.

The choice of R_{L} is particularly important so as to provide, during the formation of B, good control of the polymerization which makes it possible to maintain a high reactivity of B during the reinitiation of A. Preferably, mention will be made of the following two nitroxides X1 and X2:

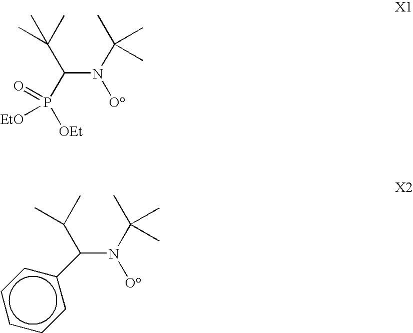

The manufacturing process thus consists in first polymerizing the B block in the presence of an initiator of formula II and optionally of an additional amount of compound X at a temperature of between 60° C. and 150° C., under a pressure ranging from 1 to 10 bars. The polymerization can be carried out in the presence or absence of a solvent or in a dispersed medium. The polymerization is halted before 90% conversion. The choice is made to evaporate or not to evaporate the residual monomer of the B block according to the facility related to the process of synthesis. The amount of monomer for the A block is then added. The polymerization of the A block is carried out under conditions similar to those of the B block. The polymerization of the A block is continued to the targeted conversion. The product is recovered simply by drying the polymer according to a means known to a person skilled in the art. During this stage, the various additives necessary for the UV and thermal protection required for the acrylic film application are added and a film with the desired thickness is produced by extrusion with a flat die.

The material obtained comprises at least 95% of block copolymers. Optionally, an amount of homopolymer A may be added so that the level of copolymer present in the material is between 95 and 100%. This addition may prove to be necessary during the formation of the A block as the conversion of the final traces of monomers may lead a person skilled in the art to add a fresh initiator capable of converting these residual monomers. Within these limits, the properties of the material are in accordance with a use as acrylic film.

The film of the invention initially comprises all the additives necessary for its use and for its coloring, such as organic or inorganic pigments.

The film of the invention can be obtained by well known extrusion techniques, such as calendering, extrusion blow-molding and extrusion casting.

The film of the invention is provided in the form of a thin layer with a thickness of between 50 and 200 microns and preferably between 70 and 90 microns.

Generally, the films produced according to the invention exhibit domains with an elastomeric nature with a size of less than 50 nm, a modulus of elasticity of between 300 and 1800 MPa, an elongation at break of greater than 60% and a haze of less than 2.

The film of the invention can be used as surface treatment for the protection of materials, such as ABS, PVC, PS, PP or PC. Mention may be made, among the protection techniques, by way of indication and without limitation, of in-mold decoration, lamination decoration, the coating of screens and as paint substitute.

The invention also relates to the components treated as described above and to the use of these components in various applications, in particular those requiring, inter alia, good stability within a wide temperature range. This is because the film of the invention exhibits a good transparency (haze less than 2) which remains virtually constant whatever the operating temperature chosen between −40 and 100° C.

### EXAMPLES

The following abbreviations will appear in the description of the examples:

BuA: Butyl acrylate

MMA: Methyl methacrylate

MAA: Methacrylic acid

PI: Polydispersity index

M_{w}: Weight-average mass

DTDDS: tert-Dodecyl disulfide

The materials are characterized using standard analytical methods. The molecular masses are determined using steric exclusion chromatography and are expressed as polystyrene equivalents. In addition, the content of block copolymer is measured by a technique referred to as liquid absorption chromatography.

The films are produced with a Rheocord laboratory thermoplastic screw extruder through a flat die. The films subsequently pass into a thermally regulated 3-roll calender and are then cooled in a water bath.

Before extrusion, the samples are stored under vacuum at 80° C. for a minimum of 3 h.
Temperatures extruder zones 1,2,3: 175° C.
Temperatures die zone 4: 190° C.
Speed screw: 33 revolutions/min
Distance between die and calender roll axis: on contact
Die gap: 0.1 mm
Thickness of the films: 100 to 150 μm
The screw is purged 1 hopper before withdrawal or dismantled and cleaned.

The films thus obtained were evaluated mechanically and optically according to the respective standards:
Standard ASTM D882: Determination of the tensile properties on films
Standard ASTM D1003: Determination of the total luminous transmittance and of the haze

An analysis using an atomic force microscope (Digital Instrument, Dimension 3100) made it possible to confirm the fact that the size of the domains of low T_{g} (which appear dark on the photographs) is indeed less than 50 nm.

Example of the synthesis of a block copolymer and size of the domains of low T_{g}:

### Preparation of the B Block

6000 g of n-butyl acrylate, 65 g of initiator II1 (corresponding to the formula below) and 3.2 g of excess nitroxide Xl (i.e., an II1/X1 molar ratio of 7%) are introduced into a metal reactor equipped with a mechanical stirrer and with a jacket. The temperature of the reaction medium is brought to 115° C.

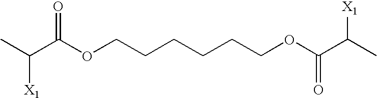

After 225 minutes, the conversion of the n-butyl acrylate is 55.3%. A withdrawn sample makes it possible to determine, by steric exclusion chromatography, the characteristics of the B block thus produced.

| Number-average mass Mₙ: | 33 000 Da |
|---|---|
| Weight-average mass M_{w}: | 44 000 Da |
| Polydispersity index PI = M_{w}/Mₙ: | 1.3 |

### Preparation of the A Block

2000 g of methyl ethyl ketone, 4000 g of MMA and 444 g of methacrylic acid are then run into the reactor. The polymerization of the A block is carried out at a temperature of 90° C.
Conversion achieved: 51%
The analysis by steric exclusion chromatography of the copolymer is then as follows:

| Number-average mass Mₙ: | 77 160 Da |
|---|---|
| Weight-average mass M_{w}: | 134 000 Da |
| Polydispersity index PI: | 1.75 |

The analysis of the composition by ¹H NMR shows:

| | |
|---|---|
| Content of n-butyl acrylate: | 42% |
| Content of methyl methacrylate: | 53% |
| Content of methacrylic acid: | 5% |

Size of the domains: The AFM photo given in Appendix 1 shows the elastomeric domain sizes which are much less than 50 nm.
Synthesis of examples 1, 2 and 3
The synthetic conditions of the following examples are given in the following table (in these examples, the butyl acrylate (BuA) remaining at the end of the B block is retained for the synthesis of the A block)

References

| | 1 | 2 | 3 |
|---|---|---|---|
| Comonomers | BuA/MMA | BuA/MMA | BuA/MMA |
| composition targeted | 50/50 | 40/60 | 60/45 |
| initiator | II1 | II1 | II1 |
| B Block | | | |
| Monomer | BuA | BuA | BuA |
| (+ composition) | 100 | 100 | 100 |
| theoretical Mₙ | 60 000 | 45 000 | 45 000 |
| excess of X1/function | 5% | 5% | 5% |
| conversion obtained (%) | 67 | 55.3 | 55.3 |
| duration (min) | 180 | 180 | 180 |
| Mₙ | 40 000 | 42 000 | 43 000 |
| M_{w} | 72 000 | 76 000 | 61 150 |
| PI | 1.8 | 1.8 | 1.4 |
| A Block | | | |
| Monomers | MMA/BuA | MMA/BuA | MMA/BuA |
| (+ composition) | 75/25 | 100 | 100 |
| conversions targeted (%) | 100 | 100 | 55 |
| conversion obtained (%) | 83 | 63 | 57 |
| duration (min) | 130 | 145 | 140 |
| DTDDS(ppm) | 100 | 100 | 60 |
| Di(tert-dodecyl) sulfide | | | |
| Final composition | 54% PMMA | 59% PMMA | 67% PMMA |
| | 46% PBuA | 41% PBuA | 33% PBuA |
| A Block | 62% | 61% | 70% |
| B Block | 38% | 39% | 30% |
| Mₙ | 71 000 | 71 130 | 72 220 |
| M_{w} | 139 000 | 138 600 | 143 000 |
| PI | 1.9 | 1.9 | 1.95 |

### Example 1

### According to the Invention

Composition: MMA 54%; BuA 46%; M₂=139 000 Da; PI=1.9
Haze (%)<2
Modulus (MPa)=368
Plastic yield point (MPa)=8.5
Deformation at break (%)=125

### Example 2

### According to the Invention

Composition: MMA 59%; BuA 41%; M_{w}=138 000 Da; PI=1.9
Haze (%)<2
Modulus (MPa)=451
Plastic yield point (MPa)=15.6
Deformation at break (%)=79

### Example 3

### According to the Invention

Composition: MMA 67%; BuA 33%; M_{w}=143 000 Da; PI=1.95
Haze (%)<2
Modulus (MPa)=921
Plastic yield point (MPa)=28.4
Deformation at break (%)=56

### Example 4: (Comparative)

A block copolymer with an Mₙ of 83 000 Da and an M_{w} of 108 000 Da comprising 48% of n-butyl acrylate and 52% of methyl methacrylate is prepared according to patent JP2000-397401. The product obtained is placed in an oven under a nitrogen atmosphere at 200° C. for 1 hour. The polymer darkens and cannot be extruded to form a film without decomposition.

### Example 5: (Comparative)

| Copo: nature | BuA/MMA |
|---|---|
| Initiator | II1 |
| 1st Block: nature | BuA |
| (+ composition) | 100 |
| Mₙ | 60 000 |
| Duration (min) | 240 |
| Mₙ | 54 910 |
| M_{w} | 80 000 |
| PI | 1.4 |
| 2nd Block: nature | MMA/MAA |
| (+ composition) | 99/1 |
| Conversion (%) | 55 |
| Duration (min) | 100 |
| DTDDS (ppm) | 100 |
| Final composition | 44.5% MMA |
| | 55% BuA |
| | 0.5 MAA |
| | 0.44 |
| Mₙ (PS eq) | 101 600 |
| M_{w} (PS eq) | 209 500 |
| PI | 2 |

Modulus: 7 MPa

This product is sticky and cannot be extruded to form a film. This example illustrates the importance of the choice of the amount of acrylate present in the block copolymer and the fact that not all the copolymers claimed in WO 97/27233 can be used as a monolayer film.

What is claimed is:

1. A film obtained by techniques for the conversion of thermoplastics, such as extrusion, starting from a composition comprising:
from 95 to 100% by weight of at least one block copolymer corresponding to the formula (A)ₘ-(B)ₙ-I and
from 0 to 5% by weight of at least one polymer A, n being an integer greater than or equal to 2, m being an integer less than or equal to n, B being a polymer block, bonded directly to the core I via a covalent bond, obtained by the polymerization of a mixture of monomers (B₀) comprising at least 60% by weight of acrylic monomers (b₁) and A being a polymer block, bonded directly to the B block via a covalent bond, obtained by the polymerization of a mixture of monomers (A₀) comprising at least 60% by weight of methacrylic monomers (a₁), the core (I) being an organic group corresponding to one of the following formulae: 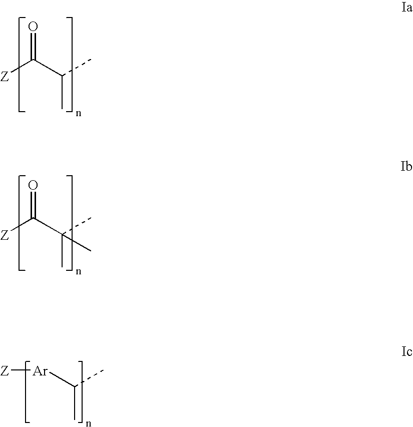
in which Ar denotes a substituted aromatic group and Z denotes a polyfunctional organic or inorganic radical with a molar mass of greater than or equal to 14.

2. The film as claimed in claim 1, characterized in that said polyfunctional organic radical is chosen from 1,2-ethanedioxy, 1,3-propane-dioxy, 1,4-butanedioxy, 1,6-hexanedioxy, 1,3,5-tris(2-ethoxy)cyanuric acid, polyaminoamine, such as polyethyleneamines or 1,3,5-tris(2-ethylamino)-cyanuric acid, polythioxy, phosphonate or polyphosphonate radicals.

3. The film as claimed in claim 1, characterized in that said polyfunctional inorganic radical is chosen from complexes of formula Mⁿ⁺O⁻ₙ in which M is a magnesium, calcium, aluminum, titanium, zirconium, chromium, molybdenum, tungsten, manganese, iron, cobalt, nickel, palladium, platinum, copper, silver, gold, zinc or tin atom.

4. The film as claimed in any one of claims 1 to 3, characterized in that it is obtained according to the controlled polymerization process consisting of
the polymerization at a temperature of between 60 and 150° C. of the mixture B₀ in the presence of an alkoxyamine and of an agent for controlling the polymerization up to a degree of conversion of 90%,
the removal of a portion or of all of the unreacted monomers B₀,
the addition and the polymerization of the mixture A₀,
the removal of all of the unreacted monomers and recovery of the copolymer formed.

5. The film as claimed in claim 4, characterized in that the alkoxyamine is chosen from the compounds corresponding to one of the following formulae:

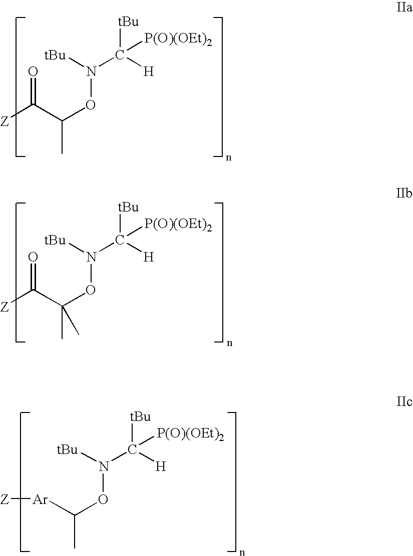

6. The film as claimed in claim 4 or 5, characterized in that the control agent is chosen from the compounds corresponding to one of the following formulae:

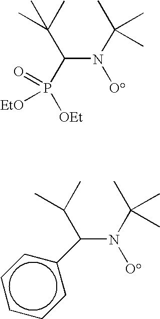

7. The film as claimed in one of the preceding claims, characterized in that the mixture of monomers B₀ comprises:
from 60 to 100% by weight of acrylic monomers (b₁) chosen from alkyl acrylates with an alkyl chain comprising at least two carbon atoms and preferably at least four carbon atoms, such as butyl acrylate, octyl acrylate, nonyl acrylate, 2-ethylhexyl acrylate, polyethylene glycol acrylates or acrylonitrile,
from 0 to 40% by weight of monomers (b₂) chosen from monomers which can be polymerized by the radical route, such as ethylenic, vinyl and similar monomers.

8. The film as claimed in any one of the preceding claims, characterized in that the mixture A₀ comprises
from 60 to 100% by weight of at least one methacrylic monomer (a₁) chosen from alkyl methacrylates, such as methyl, butyl, octyl, nonyl or 2-ethylhexyl methacrylate, or also functional methacrylic derivatives, such as methacrylic acid, glycidyl methacrylate, methacrylonitrile or any methacrylate comprising an alcohol, amide or amine functional group,
from 0 to 40% by weight of at least one monomer chosen from anhydrides, such as maleic anhydride, vinylaromatic monomers, such as styrene or its derivatives, in particular α-methylstyrene, and the monomers corresponding to (b₁).

9. The film as claimed in any one of the preceding claims, characterized in that the monomers B₀ represent from 10 to 60% by weight of the total weight of the monomers composing the copolymer.

10. The film as claimed in any one of the preceding claims, characterized in that the B block represents from 10 to 50% by weight of the copolymer and preferably between 20 and 50%.

11. The film as claimed in one of the preceding claims, characterized in that the B block exhibits a T_{g} of less than 0° C.

12. The film as claimed in any one of the preceding claims, characterized in that it exhibits elastomeric domains B with a size of less than 50 nm.

13. The film as claimed in any one of the preceding claims, characterized in that it exhibits a thickness of between 50 and 200 microns and preferably between 70 and 90 microns.

14. The film as claimed in any one of the preceding claims, having a modulus of elasticity of between 300 and 1800 MPa, a haze of less than 2 and an elongation at break of greater than 60%.

15. The film as claimed in any one of the preceding claims, characterized in that it additionally comprises an inorganic or organic pigment.

16. The use of a film as claimed in any one of claims 1 to 15, as surface treatment for the protection of materials of acrylonitrile-butadiene-styrene (ABS), polycarbonate (PC), poly(vinyl chloride) (PVC), polystyrene (PS), high impact polystyrene (HIPS) or polypropylene(PP) type.

17. The use of a film as claimed in any one of claims 1 to 15 in in-mold decoration.

18. The use of a film as claimed in any one of claims 1 to 15 in lamination decoration.

19. The use of a film as claimed in any one of claims 1 to 15 for the coating of screens.

20. The use of a film as claimed in any one of claims 1 to 15 as paint substitute.

21. A component based on PS, PC, PP, PVC or ABS, surface treated as claimed in any one of claims 16 to 20.

22. The use of the component as claimed in claim 21 at a temperature ranging from −40 to 100° C.
